(19) United States
(12) Patent Application Publication
(10) Pub. No.: US 2006/0218039 A1
(43) Pub. Date: Sep. 28, 2006

(54) Enhanced fast food restaurant and method of operation

(76) Inventor: Neldon P. Johnson, Salem, UT (US)

Correspondence Address: J. David Nelson;NELSON, SNUFFER, DAHLE & POULSEN, P.C., 10885 South State Street, Sandy, UT, 84070, US

(21) Appl. No.: 11/065,965

(22) Filed: Feb. 25, 2005

(51) Int. Cl. G06Q 30/00

(52) U.S. Cl. 705/15

(57) ABSTRACT

A fast food restaurant and method of operating a fast food restaurant, the restaurant having an order and staging station for drive through customers. The order and staging station has a plurality of order stalls for customer vehicles, each order stall having an order panel with a menu display and a touch screen or voice or speech activator for self-service menu item selection and order placement. The order panel also has a payment acceptor and an order status reporter. The customer vehicle remains in the order stall until the customer is notified that the order is ready for pickup at a delivery station.

### FIELD OF THE INVENTION

This invention is in the field of fast food restaurants and in particular in the field of fast food restaurants with drive through service.

### BACKGROUND OF THE INVENTION

Fast food restaurants, most of which offer optional drive through service, have been common place in the United States and many other countries for a number of years. For most of the fast food restaurants which offer optional drive through service, drive through sales exceed inside sales.

In order for a fast food restaurant to accommodate drive through customers, substantial limitations are imposed on the amount of time allocated for order selection when the customer looks at a menu at a selection position and makes menu item selections for his or her order, for order placement when the customer informs the restaurant at a placement position of the order selection for his or her order, for order payment when the customer pays for the order by card or cash at a payment position, for order preparation when the restaurant prepares the order at a preparation position and packages it for delivery, and for order delivery when the restaurant delivers the order to the customer at a delivery position. Menus are generally limited to menu items which are pre-prepared or are prepared after the order is placed but from pre-prepared components.

The steps of order selection, order placement, order payment, order preparation, and order delivery must generally be accomplished sequentially. A possible exception is order payment and order preparation which some fast food restaurants choose to perform concurrently to save time, choosing to rely on the accuracy of the order placement. In other words, restaurants may choose to begin the step of order preparation immediately upon completion of order placement and before order payment. Because the customer vehicle stream of customer vehicles is generally a single line of vehicles which starts upstream of the order selection position and continues downstream to the order delivery position, any delay experienced at any step for any customer results in a delay being experienced by all other customers upstream. This has resulted in fast food restaurants having to substantially limit their menus and carefully refine their menu item preparation methodology. Some fast food restaurants deal with potential delays by having a customer who has paid, but has not received his or her order, move out of the vehicle stream to a waiting position. However, this then requires an employee being specifically directed to deliver the order and that employee leaving the preparation position, manually taking the order out of the building containing the preparation position, and delivering the order to the customer in his or her vehicle at the waiting position.

Some fast food chains, in particular for their newer restaurants, split the customer at the order selection and order placement position, recognizing that the steps of customer menu item selection and order placement are often a bottleneck. For those restaurants, the customer vehicle stream is simply divided at the top of the stream and then flows together prior to the payment position. Some fast food chains, particularly with their older restaurants, have a common payment position and delivery position. That method is based on the presumption that the step of order preparation takes more time than the step of order payment and the step of order delivery combined.

It is an object of the present invention to provide an enhanced fast food restaurant and a method for enhanced fast food restaurant operation which reduce bottlenecks in the customer vehicle stream.

It is a further object of the present invention to provide an enhanced fast food restaurant and a method for enhanced fast food restaurant operation which allow for greater menu item variety involving a wider variety of preparation times and preparation steps.

It is a further object of the present invention to provide an enhanced fast food restaurant and a method for enhanced fast food restaurant operation which allow for greater flexibility in the amount of time taken by customers in the order selection step, allowing rapid selection by some customers and delayed selection by other customers without delaying customers upstream.

It is a further object of the present invention to provide an enhanced fast food restaurant and a method for enhanced fast food restaurant operation which allow for greater flexibility in the amount of time taken by customers in the order placement step, allowing rapid placement by some customers and delayed placement by other customers without delaying customers upstream.

It is a further object of the present invention to provide an enhanced fast food restaurant and a method for enhanced fast food restaurant operation which allow for greater flexibility in the amount of time taken by customers in the order payment step, allowing rapid payment by some customers and delayed payment by other customers without delaying customers upstream.

It is a further object of the present invention to provide an enhanced fast food restaurant and a method for enhanced fast food restaurant operation which provide for automated order selection, automated order placement, automated order payment, and automated change dispensing for drive through and inside customers, thereby reducing personnel and labor costs.

It is a further object of the present invention to provide an enhanced fast food restaurant and a method for enhanced fast food restaurant operation which provide for additional security against theft and sweetheart losses, with employees not being involved with the receipt of drive through or inside customer payments or the dispensing of customer change in the case of cash payments.

It is a further objective of the present invention to provide an enhanced fast food restaurant and a method for enhanced fast food restaurant operation which provide for customers to self-order menu items, self-pay for the menu items, and take delivery of the menu items while physically remaining in a vehicle.

### SUMMARY OF THE INVENTION

A preferred embodiment of the enhanced fast food restaurant of the present invention comprises a drive through vehicle access, an order and staging station with a plurality of order stalls where incoming customer vehicles are parked and customers in the vehicle make menu selections for one or more orders from a self-service order panel and wait for notification that the orders are ready for delivery. Each order panel is positioned in the respective order stall so as to be proximal to the driver's window of a customer vehicle when it is parked in the park stall in the order position.

The order panel, based on current technology, will preferably be either voice or speech activated or will incorporate a touch screen. Each order and staging station has a menu display, which, based upon current technology, is preferably a menu display screen, for displaying, on one or more pages, a complete listing of all available menu items with their respective prices and other menu item information as desired. At the present time a touch screen would be a preferred interaction means and a preferred order selection and placement means. However, as speech recognition software improves, it is likely that a speech activator may become a preferred order selection means for the order panel. If a touch screen is used it would preferably be positioned to be reached through the driver's window by a person seated in the driver's seat of the customer vehicle.

For preferred embodiments the order panel will include an automated, self-service payment acceptor. Based on current technology the payment acceptor would include the magnetic strip card reader for credit cards, debit cards, EBT cards and other types of widely used cards which utilize a magnetic strip. The payment acceptor would also preferably include a currency acceptor and a coin acceptor. The payment acceptor could also include a change dispenser, but a change dispenser positioned at the order delivery station where orders are picked up is preferred for enhanced security. The order panel may also include a receipt printer which may include a scanable code for use at a change dispenser for the receipt of change and at the delivery station for identification of the customer's order for delivery.

The order panel, for preferred embodiments, will also have an order status reporter, which may simply be a visual status report presented on the display screen or in a block in the display screen, or may be a separate visual or auditory order status reporter, such as a LCD display, video display, speaker or annunciator, which can advise the customer when the order is ready or can advise the customer periodically of the estimated length of time before the order is ready. Depending upon local climatic conditions, the order and staging station may be equipped with a canopy for weather protection.

The order panels, for preferred embodiments, will be interconnected with the order preparation station and the delivery station by wire or wireless order communicating means which will be known to persons skilled in the art. Additional order communicating means will undoubtedly be developed with additional technological advances.

The customer or customers in the vehicle will typically remain in their vehicle with the vehicle parked in the order stall at the order and staging station until being notified that the order or orders originating from the vehicle are ready for pick up at the delivery station. At that time the driver of the vehicle will drive the vehicle from the order stall to the delivery station and obtain change and order delivery by scanning a receipt, using a touch screen or voice or speech activator to identify the customer's order.

The preferred embodiment of the present invention also includes a vehicle dining area with dining stalls where customers can park their vehicle after picking up their order. The enhanced fast food restaurant of the present invention may also include an interior dining area which would preferably be included in the main restaurant building which would also house the food preparation area and the restrooms.

The preferred embodiment of the present invention also includes an interior dining area. Walk-in customers could be handled like walk-in customers for any other fast food restaurant but preferred embodiments utilize a plurality of interior order panels positioned apart from the interior delivery station. The interior order panels could be identical to order panels at the order and staging station or could include change dispensers. Alternatively, the interior order panel could provide only for order selection and placement with payment being made at a separate interior payment station. A paper receipt, electronic receipt, voice or speech recognition or biometric could be used for customer identification for payment and could be used at the interior delivery station to identify the customer for order pick up. One or more order status display screens would be positioned in the dining area to inform customers of the status of their order and ultimately readiness for pick up at the interior delivery station. With preferred embodiments utilizing the automated self order and self payment features of the interior order panel, labor will be limited to menu item preparation and delivery personnel.

In addition to the menu flexibility and customer convenience afforded by the present invention due to the staging of the ordering process, the payment process and the delivery process, increasing automation of the ordering and payment process for fast food restaurants offers a number of additional potential advantages, including reducing transaction time, reducing labor costs, increasing profits, reducing prices to customers, reducing customer and employee theft, reducing fraud losses, increasing collectability of credit/debit/EBT card purchases and reducing risk to personnel. The present invention may also provide for Internet placement of advance orders with pick up at the delivery station or the interior delivery station at a pre-selected time.

### BRIEF DESCRIPTION OF THE DRAWINGS

FIG. 1 is a plan view of a preferred embodiment of the enhanced fast food restaurant of the present invention.

FIG. 2 is a plan view detail of a vehicle order and staging station of a preferred embodiment of the enhanced fast food restaurant of the present invention.

FIG. 3 is a front elevation view detail of a preferred embodiment of an exterior order panel of the present invention.

FIG. 4 is a plan view detail of a an alternative preferred embodiment of the enhanced fast food restaurant of the present invention.

### DETAILED DESCRIPTION

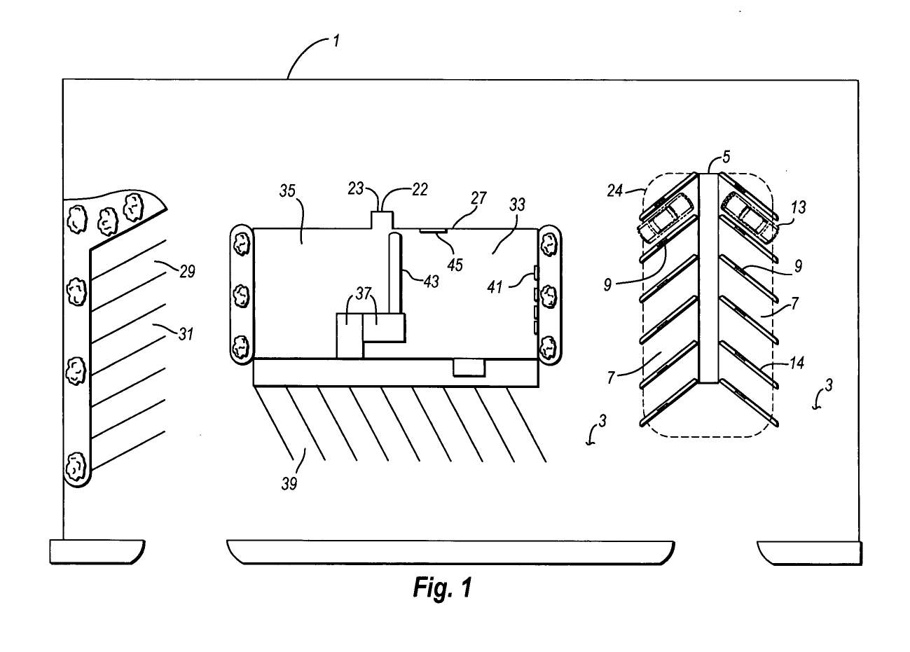

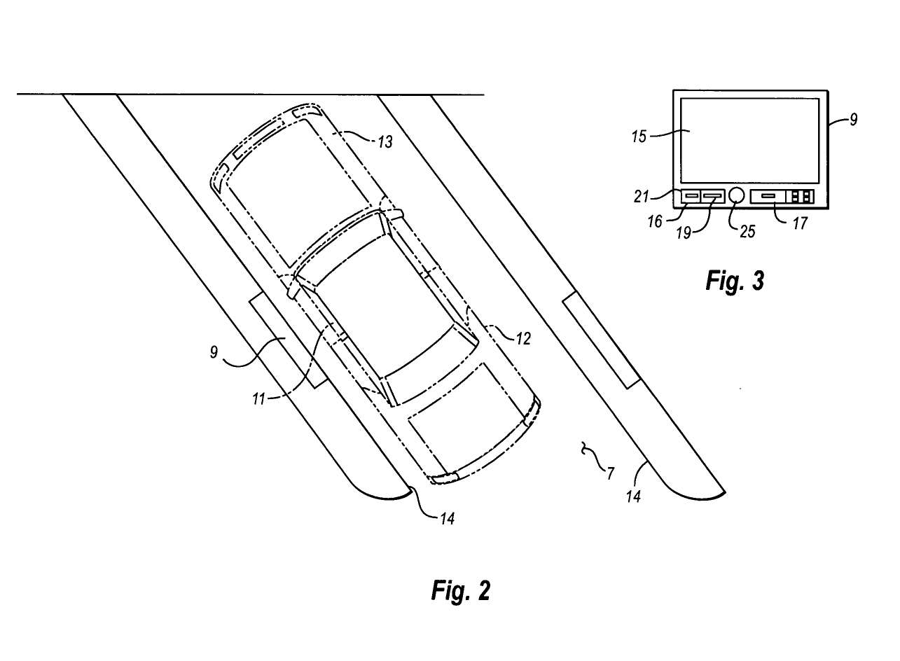

Referring first to FIG. 1 a preferred embodiment of the enhanced fast food restaurant 1 of the present invention is shown. This embodiment comprises a drive through vehicle access 3, an order and staging station 5 with a plurality of order stalls 7 where incoming customer vehicles are parked and customers in the vehicle make menu selections for one or more orders from a self-service order panel 9 and wait for notification that the orders are ready for delivery. Referring also to FIG. 2, each order panel is positioned in the respective order stall so as to be proximal to the driver's window 11 of a customer vehicle 13 when it is parked in the park stall in the order position 12. The order panel can be mounted to a panel post suspended from an overhead canopy 24 or mounted atop a panel post which is anchored in a barrier curb 14. The barrier curb protects the order panel from impact with customer vehicles entering or exiting the order stall serviced by the order panel and with customer vehicles entering or exiting adjacent the adjacent order stall. Power and communication can be provided to the order panel through the panel post. Other order panel support means will be known to persons skilled in the art.

Referring now to FIG. 3, the order panel 9, for preferred embodiments, based on current technology, will preferably be either voice or speech activated or will incorporate a touch screen. Other interaction means will be known to persons skilled in the art for interaction of the customer with the order panel. Each order and staging station has a menu display, which, based upon current technology, is preferably a menu display screen 15, for displaying, on one or more pages, a complete listing of all available menu items with their respective prices. Other menu item information, such as approximate preparation time and nutritional information such as fat content and sodium content can be displayed.

At the present time a touch screen would be a preferred interaction means and a preferred order selection means whereby the customer or customers in each vehicle would select the menu items they wish to have included in their respective orders. However, as voice recognition software improves, it is likely that a voice activator may become a preferred order selection means for the order panel. If a touch screen is used, the menu display screen 15 would preferably be a menu touch screen and would be positioned to be reached through the driver's window 11 by a person seated in the driver's seat of the customer vehicle.

For preferred embodiments the order panel will include an automated, self-service payment acceptor 16. Based on current technology the payment acceptor would include the magnetic strip card reader 17 for credit cards, debit cards, EBT cards and other types of widely used cards which utilize a magnetic strip. The payment acceptor would also preferably include a currency acceptor 19 and a coin acceptor 21. The payment acceptor could also include a change dispenser, which would comprise a currency dispenser and a coin dispenser for making change when payment is made by cash. However, the inventor prefers that currency change and coin change be dispensed by a change dispenser 22 positioned at the order delivery station 23 where orders are picked up. This provides for greater security for the substantial amount of cash that must be kept on hand to provide for the return of change when payment is made in cash.

The order panel may also include a receipt printer. For these embodiments the receipt printer would preferably place a bar code or some other scanable code on the receipt. This code can then be scanned by the customer at a separate change dispenser station for the receipt of change and at the delivery station for identification of the customer's order for delivery. Alternatively the receipt can be scanned at the delivery station both for the dispensing of change and for identification of the customer's order for delivery.

The order panel, for preferred embodiments, will also have an order status reporter, which may simply be a visual status report presented on the display screen or in a block in the display screen, or may be a separate visual or auditory order status reporter 25 mounted in the order panel. This could be as simple as LCD display or an annunciator which is sounded when the customer's order is ready for pick up at the delivery station. Alternatively, it could include a separate video display or a speaker with an auditory voice signal, or both, advising the customer periodically of the estimated length of time before his or her order is ready for delivery and then finally informing the customer when the order is ready for delivery at the delivery station. Depending upon local climatic conditions, the order and staging station may be equipped with a canopy 24 for weather protection of the order and staging station equipment and the customer vehicles while they are parked in order stalls.

The order panels, for preferred embodiments, will be interconnected with the order preparation station and the delivery station by wire or wireless order communicating means which will be known to persons skilled in the art. Additional order communicating means will undoubtedly be developed with additional technological advances.

The customer or customers in the vehicle will typically remain in their vehicle with the vehicle parked in the order stall at the order and staging station until being notified that the order or orders originating from the vehicle are ready for pick up at the delivery station.

At that time the driver of the vehicle will drive the vehicle from the order stall to the delivery station 23, which can be a typical drive up window on the main restaurant building 27. Here, if the customer is expecting change from a cash purchase, the customer will scan a receipt or otherwise interact with the change dispenser and receive currency and coin change that is due. A single scanner at the delivery station could be used for a customer to scan his or her receipt to enable him or her to receive change as due and to identify the customer's order for delivery. Current technology could also provide for the customer to say his or her name or some other customer identifier at the order panel and then speech recognition or voice recognition could be used at the delivery station for the dispensing of change and for order identification for delivery.

The preferred embodiment of the present invention shown in FIG. 1 also includes a vehicle dining area 29 with dining stalls 31 where customers can park their vehicle after picking up their order. The enhanced fast food restaurant of the present invention may also include an interior dining area 33 which would preferably be included in the main restaurant building 27 which would also house the food preparation area 35 and the restrooms 37. Inside customer parking 39 for inside dining customers will also be provided if interior dining is provided.

As stated above, based on current technology, a touch screen or a voice or speech activator are preferred order selection means and preferred order placement means for the order panel. However, additional order selection means and additional order placement means will be known to persons skilled in the art and additional order selection means and order placement means will undoubtedly become feasible with further advances in technology.

Preferred embodiments of the menu display means, based on current technology, utilize a video monitor. As noted above, the menu display can be incorporated in a display screen and preferably a touch screen that is used for taking the customer orders or can be used alternatively with a voice or speech activation system. Both options can also be offered to the customer for customer convenience. Other alternative menu display means such as LCD screens and the like will be known to persons skilled in the art.

Card readers for reading credit and debit cards and the like with a magnetic strip and for communicating with the payor bank or other financial institution for payment approval are commonplace. Similarly, currency acceptors and coin acceptors are now well known and highly reliable means for self payment. Other payment means for use by a customer to use to self pay for a customer order will be known to persons skilled in the art and undoubtedly additional technological advances will provide additional payment means that could be utilized with the present invention. For example, the use of a biometric sensor, such as a fingerprint sensor for confirmation of the identity of the customer utilizing a credit card, debit card or the like is currently available technology but has not gained wide usage to date. In addition to providing additional security for credit card and debit card transactions and the like, biometric sensors, speech recognition or voice recognition can be used to provide identity verification for payment by check. Any of these technologies as well as other technological advances can be incorporated into the payment means for the present invention to increase the convenience and security of payment transactions.

The embodiment of the enhanced fast food restaurant shown in FIG. 1 has only one order and staging station. However, other embodiments can provide for multiple order and staging stations which may be more compatible with a particular site and may offer additional flexibility for aesthetics.

The preferred embodiment of the present invention shown in FIG. 1 includes an interior dining area. Walk-in customers could be handled like walk-in customers for any other fast food restaurant but preferred embodiments utilize a plurality of interior order panels 41 positioned apart from the interior delivery station 43. The interior order panels could be identical to order panels at the order and staging station 5. Alternatively, each order panel could include a change dispenser for cash purchases since security concerns would be less than for the exterior order panels. Another alternative embodiment could provide for the interior order panel being used only for order selection and placement with payment being made at a separate interior payment station. A paper receipt or an electronic receipt generated at the order panel or voice recognition could be used for customer identification. Likewise a paper receipt, electronic receipt or voice recognition could be used at the interior delivery station to identify the customer for order pick up. One or more order status display screens 45 would be positioned in the dining area to inform customers of the status of their order and ultimately readiness for pick up at the interior delivery station. With preferred embodiments utilizing the automated self order and self payment features of the interior order panel, labor will be limited to menu item preparation and delivery personnel.

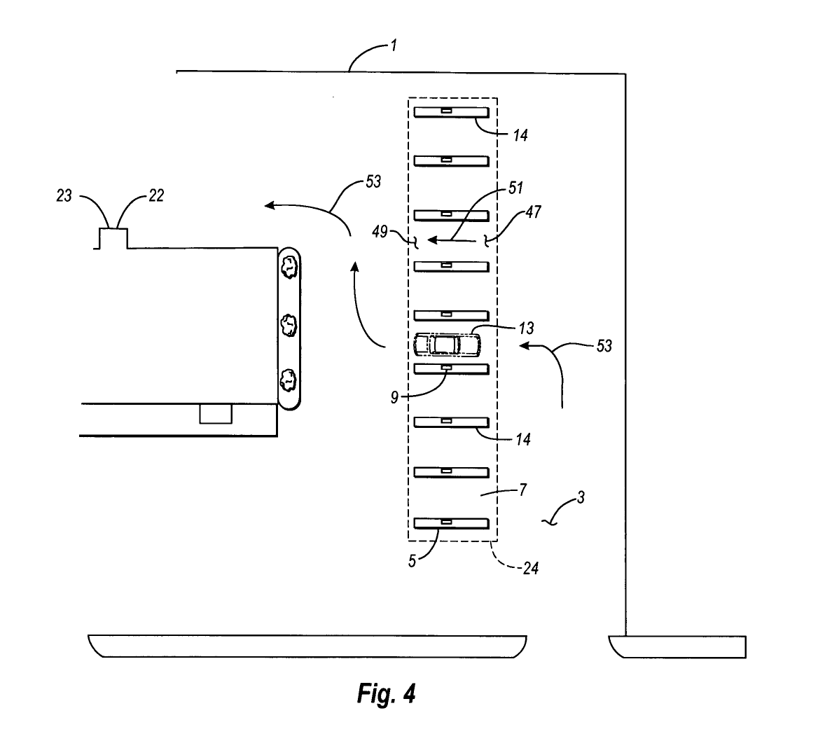

Referring now to FIG. 4, an alternative preferred embodiment of the enhanced fast food restaurant of the present invention is shown. This embodiment utilizes an order and staging station 5 which is comprised of a plurality of order stalls 7 which have an order stall entry 47 on one end of each order stall and an order stall exit 49 on the opposite end of the order stall. This provides for one directional traffic flow 51 through each order and staging station and for less disruption of the vehicle stream 53, due to the elimination of the need for vehicles to be backed into the vehicle stream. This embodiment of the order and staging station may also be equipped with an optional canopy 24 if needed for the climactic conditions.

In addition to the menu flexibility and customer convenience afforded by the present invention due to the staging of the ordering process, the payment process and the delivery process, increasing automation of the ordering and payment process for fast food restaurants offers a number of additional potential advantages, including reducing transaction time, reducing labor costs, increasing profits, reducing prices to customers, reducing customer and employee theft, reducing fraud losses, increasing collectability of credit/debit/EBT card purchases and reducing risk to personnel. Until the present invention, potential use of automation in fast food restaurant settings has been limited simply to the use of credit cards and debit cards for payment.

The automated transaction capability of the fast food restaurant of the present invention could also provide for the acceptance of personal checks and coupons in addition to cash and credit/debit/EBT cards. It could also provide for the acceptance of biometric cards or other biometric, voice or speech actuated payment authorization.

The present invention may also provide for Internet placement of advance orders with pick up at the delivery station or the interior delivery station at a pre-selected time. Preferably an Internet web site for the restaurant will include a menu display with on-line menu item selection for an order and for order placement and will include on-line payment acceptance for payment by credit cards, debit cards, EBT cards and may include on-line payment acceptance for other forms of payment such as checks and coupons. On-line payment acceptance means for various forms of payment will be known to persons skilled in the art. The web site will also preferably prompt the customer to select an order delivery time which would be the earliest time for the customer to report to the delivery station to receive delivery of the order. The Internet customer will also preferably be given an order confirmation number or be prompted to print a receipt which can be presented or scanned at the delivery station. The web site can also include an order status reporter which will allow the customer to check the status of his or her order.

It should be noted that, in most circumstances, order selection and placement takes a longer time than payment. An alternative embodiment could therefore provide for customer vehicles to be moved from an order stall to a payment stall, with each payment stall serving one or more order stalls.

Alternative embodiments may utilize speech recognition or voice recognition for selections and commands from the customers at the order and staging stations and from the restaurant employees at the order preparation station and the delivery station or any of them. Likewise speech recognition, voice recognition or biometric recognition may be used at the delivery station to prevent order mis-delivery and theft. A speech, voice or biometric input can be obtained from the customer at the order and staging station for use at the delivery station.

Other embodiments and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. Fast food restaurant having automated drive through service with flexible order selection, order placement, order payment, order preparation and order delivery times, for customer vehicles containing one or more customers, the restaurant comprising:
a) vehicle access;
b) order and staging station comprising a plurality of order stalls, each order stall having menu display, automated self-service order selection and placement means, automated payment acceptor and order status reporter;
c) order preparation station;
d) order delivery station;
e) order communicating means for transmitting respective customer orders from each order stall of the order and staging station to the order preparation station and for transmitting order status from the order preparation station to the respective order stall.

2. Restaurant as recited in claim 1 wherein the menu display, automated self-service order selection and placement means, automated payment acceptor and order status reporter are incorporated in an order panel which is positioned to be proximal to the driver's window of a customer vehicle when the customer vehicle is parked in an order position in the order stall.

3. Restaurant as recited in claim 1 further comprising an interior dining area and an interior delivery station.

4. Restaurant as recited in claim 3 further comprising interior menu display, interior automated self-service order selection and placement means, interior automated payment acceptor and interior order status reporter.

5. Restaurant as recited in claim 3 further comprising one or more interior order panels.

6. Restaurant as recited in claim 5 wherein the interior order panels comprise menu display, automated self-service order selection and placement means, automated payment acceptor and order status reporter.

7. Restaurant as recited in claim 1 wherein the menu display and the order selection and placement means comprise a touch screen.

8. Restaurant as recited in claim 1 wherein the order selection and placement means comprises a voice activator.

9. Restaurant as recited in claim 1 wherein the order selection and placement means comprises a speech activator.

10. Restaurant as recited in claim 1 further comprising a plurality of dining stalls.

11. Restaurant as recited in claim 1 further comprising a change dispenser.

12. Restaurant as recited in claim 1 further comprising Internet order menu display, Internet order selection and placement means, and Internet payment acceptance means.

13. Restaurant as recited in claim 12 further comprising Internet order status reporter.

14. Fast food restaurant having automated drive through service with flexible order selection, order placement, order payment, order preparation and order delivery times, for customer vehicles containing one or more customers, the restaurant comprising:
a) vehicle access;
b) order and staging station comprising a plurality of order stalls, each order stall having a self-service order panel positioned to be proximal to the driver's window of a customer vehicle when the customer vehicle is parked in an order position in the order stall, the order panel comprising a menu display, automated self-service order selection and placement means, automated payment acceptor and order status reporter;
c) order preparation station;
d) order delivery station;
e) order communicating means for transmitting respective customer orders from each order panel of the order and staging station to the order preparation station and for transmitting order status from the order preparation station to the respective order panel.

15. Restaurant as recited in claim 14 further comprising an interior dining area and an interior delivery station.

16. Restaurant as recited in claim 15 further comprising one or more interior order panels.

17. Restaurant as recited in claim 16 wherein the interior order panels comprise menu display, automated self-service order selection and placement means, automated payment acceptor, and order status reporter.

18. Restaurant as recited in claim 14 wherein the menu display and the order selection and placement means comprise a touch screen.

19. Restaurant as recited in claim 14 wherein the order selection and placement means comprises a voice activator.

20. Restaurant as recited in claim 14 wherein the order selection and placement means comprises a speech activator.

21. Restaurant as recited in claim 14 further comprising a plurality of dining stalls.

22. Restaurant as recited in claim 14 further comprising a change dispenser.

23. Restaurant as recited in claim 14 further comprising Internet order menu display, Internet order selection and placement means, and Internet payment acceptance means.

24. Restaurant as recited in claim 23 further comprising Internet order status reporter.

25. Method for operating a fast food restaurant, the restaurant providing drive through service with flexible order selection, order placement, order payment, order preparation and order delivery times, for customer vehicles having one or more customers, the method comprising the steps of:
a) providing an order and staging station with a plurality of order stalls;
b) directing each drive through customer vehicle to a respective order stall;
c) providing a visual display at each order stall of a menu of available menu items;
d) providing an automated, self-service order selection and placement device at each order stall and prompting each customer to self-select menu items for an order and to self-place the order by use of the device;
e) providing the customer with an order cost for the order;
f) accepting the customer's self payment of the order cost;
g) prompting the customer to maintain the customer vehicle parked in the order stall until being advised that the order is ready for delivery;
h) advising the customer when the order is ready for delivery;
I) directing the customer to relocate the customer vehicle to a delivery station when the order is ready for delivery; and
j) delivering the order to the customer at the delivery station.

26. Method as recited in claim 25 further comprising providing an interior dining station and an interior delivery station for inside customers.

27. Method as recited in claim 26 further comprising providing a visual display in the interior dining station of available menu items, providing one or more interior automated, self-service order selection and placement devices and prompting each interior customer to self-select menu items for an order and to self-place the order by use of a respective order selection and placement device, providing the inside customer with an order cost for the order, accepting the inside customer's self-payment of the order cost, advising the inside customer when the order is ready for delivery, and delivering the order to the inside customer at the interior delivery station.

28. Method as recited in claim 27 wherein the interior automated, self-service order selection and placement devices comprise interior order panels.

29. Method as recited in claim 28 wherein the interior order panels comprise menu display, order selection and placement means, payment acceptor, and order status reporter.

30. Method as recited in claim 25 wherein the steps of providing a visual display of menu items and electronically accepting the customer's order is accomplished though use of a touch screen.

31. Method as recited in claim 25 wherein the step of electronically accepting the customer's order is accomplished through use of a voice activator.

32. Method as recited in claim 25 wherein the step of electronically accepting the customer's order is accomplished through use of a speech activator.

33. Method as recited in claim 25 further comprising directing the customer to a plurality of optional dining stalls after delivery of the order.

34. Method as recited in claim 25 further comprising dispensing change to the customer if the customer pays with cash.

35. Method as recited in claim 25 further comprising providing Internet order menu display, Internet order selection and order placement, and Internet payment acceptance.

36. Method as recited in claim 35 further comprising providing Internet order status reporting.
